(19) United States
(12) Patent Application Publication
(10) Pub. No.: US 2009/0151108 A1
(43) Pub. Date: Jun. 18, 2009

(54) Heated Wiper Blade Assembly

(75) Inventor: John VON STACH, Sault Ste. Marie (CA)

Correspondence Address: GREENBLUM & BERNSTEIN, P.L.C., 1950 ROLAND CLARKE PLACE, RESTON, VA, 20191, US

(73) Assignee: VON STACH MARKETING GROUP INC., Ontario (CA)

(21) Appl. No.: 11/955,818

(22) Filed: Dec. 13, 2007

(51) Int. Cl. B60S 1/02

(52) U.S. Cl. 15/250.07

(57) ABSTRACT

A vehicle heated windshield wiper blade assembly suitable for use with a standard wiper arm is provided. The heated windshield wiper blade assembly of the invention comprises attachment means for connecting the assembly to the wiper arm of a vehicle, a quick connect electrical connector for connecting into a vehicle electrical system, flat electrical heating elements incorporated into the assembly between the wiper blade and the housing of the assembly which elements when activated at a given temperature will provide heat directly into the housing and indirectly to the wiper blade and wiping edge.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

This invention relates to windshield wiper systems and more particularly to a windshield wiper assembly incorporating electrical heating elements for heating a wiper blade.

### DESCRIPTION OF THE PRIOR ART

In the prior art various types of heated windshield wiper structures have been proposed.

It is known in the art to embed a heating wire within a windshield wiper squeegee (the wiping edge) and to connect that heating wire to the electrical system of a vehicle so that when the wiper is activated a heating current will provide heat. Typically, this known structure has proved relatively complex and expensive with systems in which the wire breaks down over time due to the constant heating and cooling of the wire and also as to embedding the heating element within the wiper blade and as to providing the necessary electrical wiring and control.

The object of the present invention is therefore to remedy the disadvantages of the prior art.

### SUMMARY OF THE INVENTION

In accordance with the present invention, a new and improved heated windshield wiper assembly is provided for use with a standard wiper arm.

The invention accordingly provides an easy and convenient form of heated windshield wiper assembly which is easy to manufacture and which will not wear out from the heat generated within and ambient environmental conditions.

A further object of the present invention is to provide a vehicle heated windshield wiper apparatus for cleaning the windshield of a vehicle of the type including a spring loaded wiper arm for holding the apparatus under pressure against the windshield and oscillating the apparatus across the windshield, said apparatus comprising: attachment means for connecting said apparatus with the wiper arm of the vehicle; a frameless and flexible housing said housing comprising flat electrical heating elements running the length of the apparatus arms along a center rib and connected to a wiper blade leading to a wiping edge; a quick connect electrical connector; wherein once the apparatus is securely connected to the wiper arm of the vehicle and that the quick connect has been engaged to the power supply said apparatus will generate heat which is distributed to the housing, wiper blade and wiping edge.

A still further object of the present invention is to provide a vehicle heated windshield wiper apparatus for cleaning the windshield of a vehicle of the type including a spring loaded wiper arm for holding the apparatus under pressure against the windshield and oscillating the apparatus across the windshield, said apparatus comprising: attachment means for connecting said apparatus with the wiper arm of the vehicle; a frameless and flexible housing said housing comprising flat electrical heating elements running the length of the apparatus arms along a center rib, said elements being thermofoil and epoxyed to either side of said rib, and connected to a wiper blade leading to a wiping edge; a quick connect electrical connector; a thermostat for actuating said apparatus; wherein once the apparatus is securely connected to the wiper arm of the vehicle and that the quick connect has been engaged to the power supply said apparatus will generate heat which is distributed to the housing, wiper blade and wiping edge.

Further objects and advantages of the present invention will become apparent from the following description.

### BRIEF DESCRIPTION OF THE DRAWINGS

FIG. 1 is a perspective view of a heated windshield wiper assembly for vehicles;

FIG. 2 is a top view of the wiper assembly of the present invention;

FIG. 3 is a bottom view of the wiper assembly of the present invention;

FIG. 4 is a further top view of the wiper assembly illustrating the heating elements.

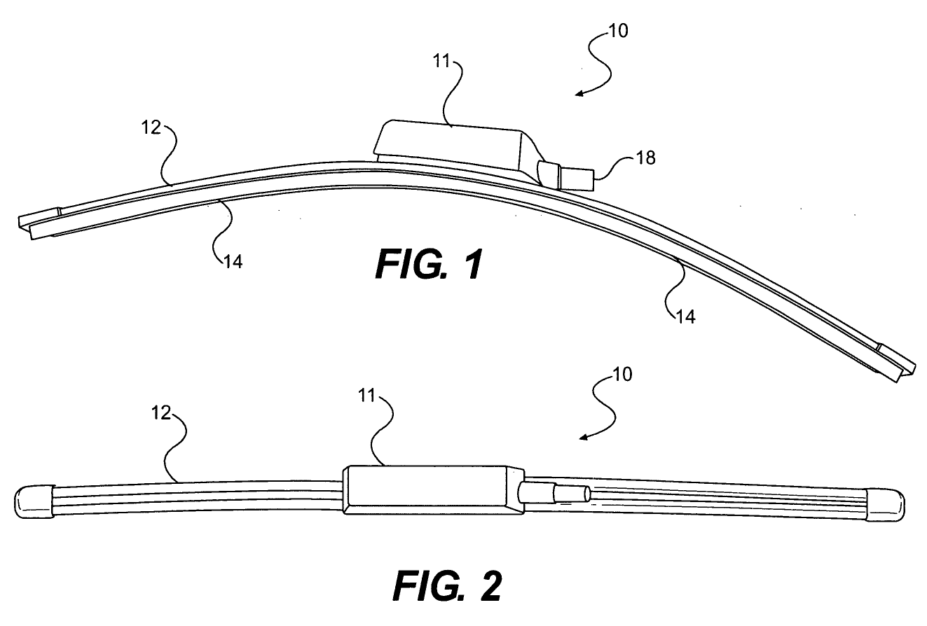

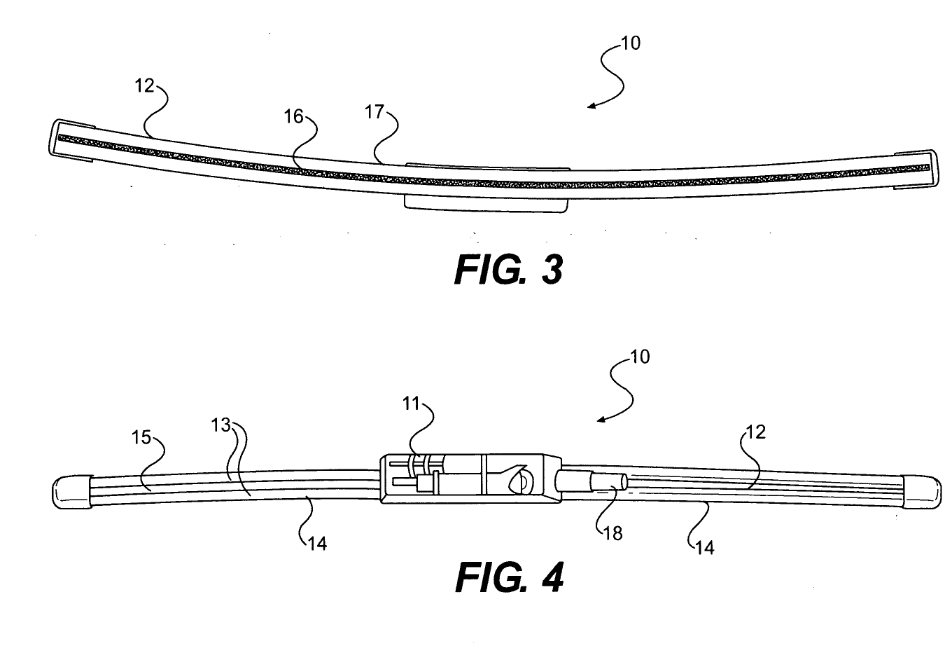

### DETAILED DESCRIPTION OF THE INVENTION

Referring to the drawings, a heated windshield wiper assembly is illustrated and designated generally as 10. The wiper blade assembly 10 may be installed and operated on an oscillating wiper arm said assembly 10 being fixedly attached through attachment means 11 which is reciprocally adapted to connect with the wiper arm of a vehicle.

Specifically, the wiper blade assembly 10 is comprised of a frameless and flexible housing 12 with centrally located attachment means 11 to connect said housing 12 to the wiper arm of a vehicle. The housing 12 is characterized by the presence, as illustrated in FIG. 4 with the housing cover off, of flat electrical heating elements 13 running the length of the assembly 10 arms 14 along a center rib 15 which is itself connected to the wiper blade 16 leading to the wiping edge 17.

Typically, the heating elements 13 are thermofoil elements, epoxyed to the top of the arms 14 and centrally wired in the area of the attachment means 11. Attached to said attachment means 11 is a quick connect electrical connector 18 for easy connection into a vehicle electrical system.

The design of the present invention promotes a more efficient use of electrical power through the use of a thermostat/temperature sensor which actuates the assembly 10 when the temperature varies beyond a fixed limit providing for the assembly 10 to start heating up at or about 4□C., for instance. As a result of the use of flat electrical heating elements 13 combined with the use of a thermostat, the heating elements 13 wear is minimized thereby leading to an increased life for the assembly 10.

It is also noteworthy that the assembly 10 is flexible said flexibility enabling the wiper blade 16 and wiping edge 17 to be self-conforming to the vehicle's windshield for improved performance.

In operation, once the wiper blade assembly 10 has been securely mounted to a wiper arm of a vehicle and that the quick connect 18 has been engaged with the wire leading to the power supply, said blade assembly 10 will generate heat, once the pre-set trigger temperature has been met. Upon application of electricity to the heating elements 13 heat will be directed into the housing 12 and indirectly to the wiper blade 16 and the wiping edge 17 resulting in snow and ice melting on the assembly 10 and also providing for improved windshield wiping performance.

It will also be appreciated that the blade assembly 10 of the present invention as embodied with its use of the quick connect 18 facilitates removal for replacement without having to replace or re-wire the entire structure. No hardware disconnection is required to replace the wiper blade assembly 10.

While a particular embodiment of the heated wiper blade assembly has been described herein, it will be appreciated by those skilled in the art that changes and modifications may be made thereto without departing from the invention in its broader aspects and as set forth in the following claims.

I claim:

1. A vehicle heated windshield wiper apparatus for cleaning the windshield of a vehicle of the type including a spring loaded wiper arm for holding the apparatus under pressure against the windshield and oscillating the apparatus across the windshield, said apparatus comprising:
attachment means for connecting said apparatus with the wiper arm of the vehicle;
a frameless and flexible housing said housing comprising flat electrical heating elements running the length of the apparatus arms along a center rib and connected to a wiper blade leading to a wiping edge;
a quick connect electrical connector;
wherein once the apparatus is securely connected to the wiper arm of the vehicle and that the quick connect has been engaged to the power supply said apparatus will generate heat which is distributed to the housing, wiper blade and wiping edge.

2. The apparatus of claim 1 wherein the heating elements are thermofoil and epoxyed to the top of the apparatus arms.

3. The apparatus of claim 1 wherein the apparatus is actuated by a thermostat/temperature sensor.

4. A vehicle heated windshield wiper apparatus for cleaning the windshield of a vehicle of the type including a spring loaded wiper arm for holding the apparatus under pressure against the windshield and oscillating the apparatus across the windshield, said apparatus comprising:
attachment means for connecting said apparatus with the wiper arm of the vehicle;
a frameless and flexible housing said housing comprising flat electrical heating elements running the length of the apparatus arms along a center rib, said elements being thermofoil and epoxyed to either side of said rib, and connected to a wiper blade leading to a wiping edge;
a quick connect electrical connector;
a thermostat for actuating said apparatus;
wherein once the apparatus is securely connected to the wiper arm of the vehicle and that the quick connect has been engaged to the power supply said apparatus will generate heat which is distributed to the housing, wiper blade and wiping edge.
